(19) United States
(12) Patent Application Publication
(10) Pub. No.: US 2007/0163159 A1
(43) Pub. Date: Jul. 19, 2007

(54) Means to operate the mobile part of an advertisement display stand with image renewal

(76) Inventor: Rafael Luis Fernandez Conesa, Malaga (ES)

Correspondence Address: WILLIAM COLLARD;COLLARD & ROE, P.C., 1077 NORTHERN BOULEVARD, ROSLYN, NY, 11576, US

(21) Appl. No.: 11/653,146

(22) Filed: Jan. 12, 2007

(30) Foreign Application Priority Data
Jan. 13, 2006 (ES) 2006-00086

(51) Int. Cl. G09F 9/37

(52) U.S. Cl. 40/446

(57) ABSTRACT

Means to operate the mobile part of an advertisement display stand with image renewal; the aforementioned display stand being the type comprising a fixed transparent part and another transparent parallel, mobile part facing it, one of them fitted with an opacity mask and the other with a number of fragmented images which are interspersed in line with the opacity pattern, so that by adjusting the position of the mobile part in relation to the fixed part, the visualization through the open spaces of the opacity mask of the fragments of one of the images or another in cooperation with the internal lighting may be selected, where the aforementioned means comprise a number of motors that act on different areas of the mobile part, these motors being synchronised by means of a circuit that enables their calibration and levelling.

### OBJECT OF THE INVENTION

The present invention refers to the means to operate the mobile part of an advertisement display stand with image renewal. These means facilitate adjustment and improve operating rate of the above-mentioned type of display stands.

### BACKGROUND OF THE INVENTION

At present, the 200501492 utility model in use regarding an advertisement display stand with image renewal is known, comprising a casing with internal illumination and an opening to display images generated by means of an internally fitted fixed part and another parallel, mobile part facing it, both transparent, and usually made up of windows or plate glass, one of them fitted with an opacity mask or pattern and the other with a number of fragmented images which are interspersed in line with the opacity pattern, so that by adjusting the position between both parts, only the fragments of a single one of the images are visible through the open spaces of the opacity mask, making up, thanks to the internal lighting, a single image visible from outside that changes or is renewed on the mobile part moving in relation to the fixed part, and the fragments of another image facing the open spaces of the opacity mask.

This utility model in use was embodied in such a way that the opacity mask and fragmented images could be indistinctly fitted into one part or another, and, in addition, the images could be printed using translucent inks onto a transparent, interchangeable plate that would be fixed and supported on a transparent piece to which the movement would be applied, facilitating image renewal by others by simply changing the plate.

The means described in this utility model in use to operate the mobile part or support piece of the interchangeable plate consist of a motor with positional control (frame by frame) and connecting-rods through which the movement of the motor is transmitted to the mobile part.

Also familiar with is patent 200501883 regarding improvements to an advertisement display stand with image renewal, where a variation to adapt it to suit street display stands is proposed in the general embodiment described in the previous utility model in use. To this end, the fixed and mobile parts are incorporated into an accessible structure based on one fixed frame and another folding one, each hinged together, the fixed frame having means to rapidly fit this structure into the urban display stand. Since the urban display stand is fitted with its own illumination, this is taken advantage of to display the images and the illumination needed by the display stand of the utility model in use is unnecessary. Besides, according to this embodiment, both frames of the structure are taken advantage of to fit one of them with the fixed, transparent part and the other with the mobile part and operating mechanisms.

None of the proposed embodiments considers means to operate the mobile part that easily allow the adjustment and setting of its movement in relation to the fixed part to be carried out, the adjustment of which is delicate since correct or incorrect image display depends on it. This disadvantage is overcome by the embodiment that the present invention considers.

### DESCRIPTION OF THE INVENTION

The means in the invention facilitate positional adjustment and movement of the mobile part of a display stand with image renewal, improve maintenance tasks and increase image interchange response rate at the same time.

In accordance with the invention, these means are applied to the mobile part of the display stand, or its mobile support piece where it consists of an interchangeable plate, and are made up of a number of position-controlled (frame by frame) movement motors, that operate on different areas of the mobile part or piece, and especially on its outer, lateral parts. Optionally, the above-mentioned motors may be replaced by linear actuators with positional control. In the first of the cases, motor movement will preferably be transmitted by means of reducers and cams and in the second case it will be the actuator rods that are directly applied to the mobile part or piece.

These motors or actuators are connected to a circuit responsible for synchronizing their movement which allows for certain, independent adjustments, for example, in carrying out necessary levelling, adjustments that will preferably be carried out by means of an external control unit in the hands of maintenance personnel.

Besides, on being fitted with several motors, image-renewal rate will also be increased.

### BRIEF DESCRIPTION OF THE DRAWINGS

FIG. 1 shows an outer view of a display stand, to which the means in the invention are applied.

FIGS. 2 and 3 each show sectional views of FIG. 1, according to both variations in the embodiment of the display stand.

FIGS. 4 and 5 respectively show enlarged details of both FIGS. 2 and 3.

FIG. 8 shows improvements to the display stand, according to which it is incorporated inside a structure that may be fitted into a street furniture display stand shown in FIGS. 6 and 7.

FIGS. 9, 10 and 11 each show views in detail of the structure's open and closed front and side to be inserted into the urban display stand according to FIG. 8.

FIGS. 12 and 13 schematically show each variation in the embodiment of the invented means. To enhance it more, only mobile part 8 is shown in the figures.

### DESCRIPTION OF A PRACTICAL EMBODIMENT OF THE INVENTION

The display stand 1, to which the means in the invention are applied, as may be seen in FIGS. 1-5, comprises a casing 2 provided with internal illumination 3 and a window or opening 4 through which the changing images are displayed.

The above-mentioned images are generated by means of an internally fitted fixed part 5 and another mobile part 8, both transparent, parallel and facing each other.

In one of these parts, 5 in this non-restrictive example, an opacity mask or pattern 6 in the shape of horizontal strips 7 has been fitted; whereas in the other part 8 a number of images have been fitted, four in this example of the invention, fragmented and interspersed in line with the above-mentioned opacity pattern, so that, by adjusting the position of part 8, only the fragments lod of a single one of the images may be seen through the open spaces 9 of the opacity pattern, fragments 10a, 10b and 10c remaining hidden from the rest of them. Due to the internal illumination 3 of the display stand, only a single image, that will change on the mobile part moving, may be seen from outside.

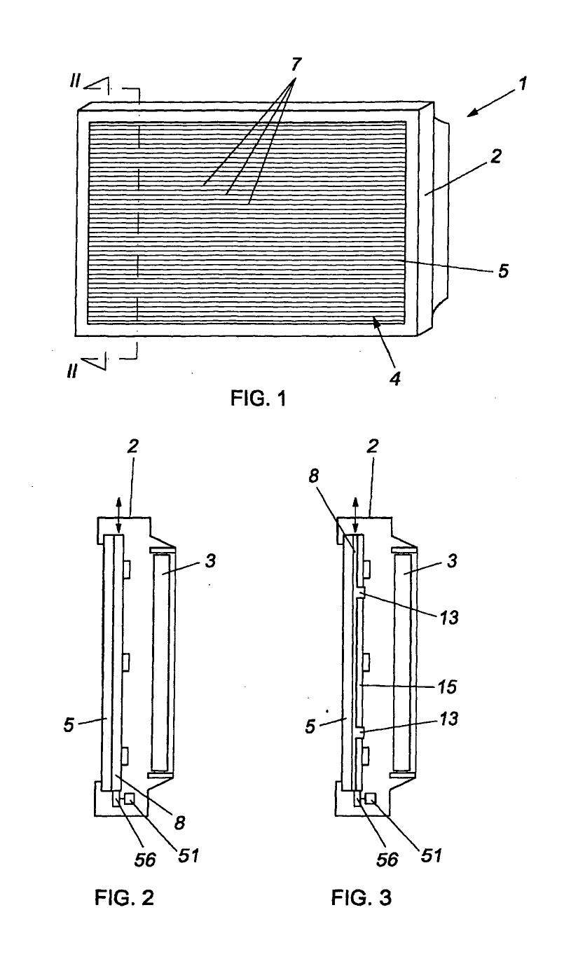

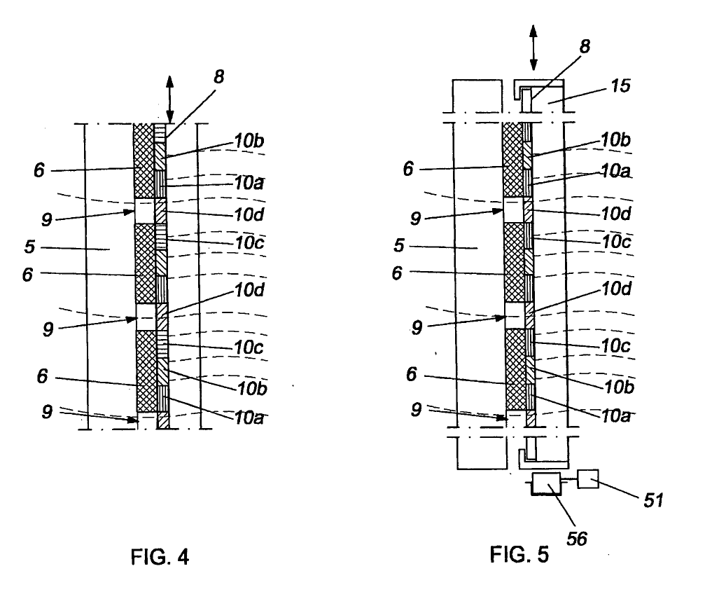

In FIGS. 2 and 4, the mobile part has sufficient stiffness to be activated by the invented operating means 50, whereas in FIGS. 3 and 5 a variation of the display stand is shown, where part 8 is a plate that is interchangeable by means of tabs 13 that are inserted to this end into slots belonging to a transparent piece 15 that supports it and on which the means 50 take effect.

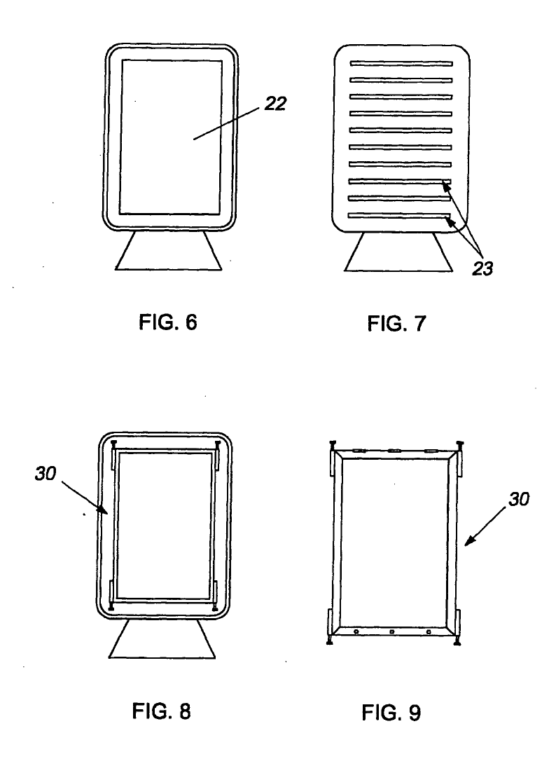

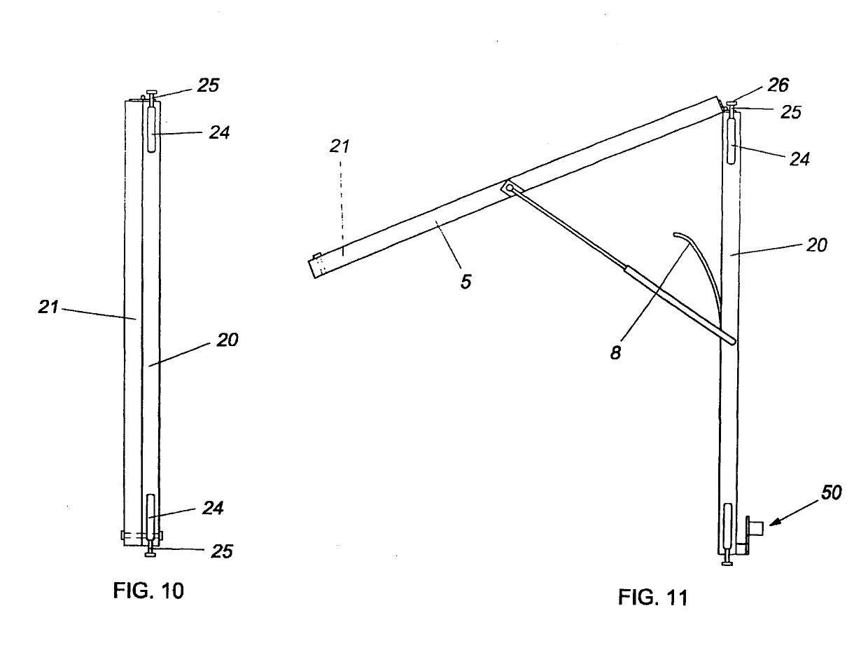

Likewise, the invented means are applicable in the case where the mobile part 8 and fixed part 5 are embodied in both frames 20, 21, hinged together, that make up a structure 30 capable of being quickly attached and fitted into an urban display stand 22 provided with its own illumination 23, as shown in FIGS. 6-11.

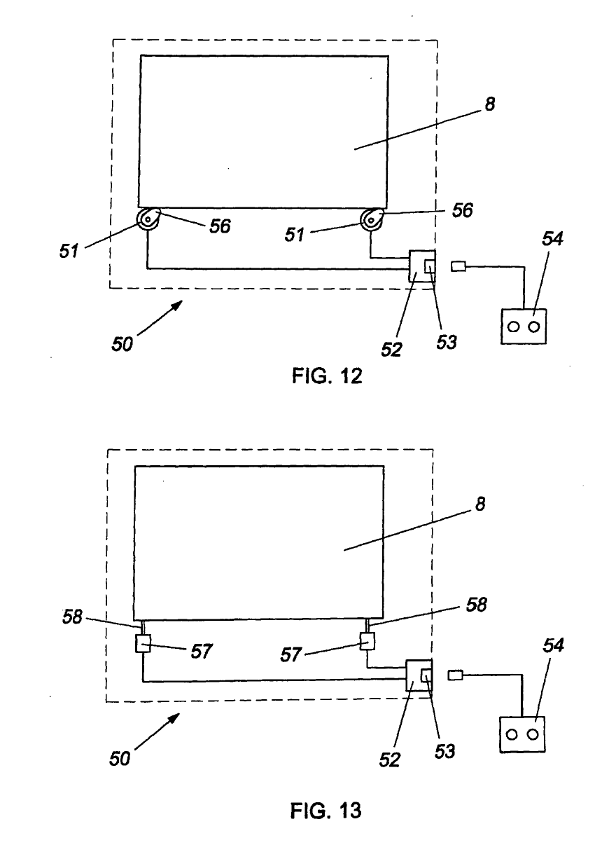

As seen in FIGS. 12 and 13, to obtain mobile part 8's movement adjustment and levelling, the present invention proposes operating means 50 made up of a number of synchronized motors, with positional control, which additionally also improve image-renewal response rate. The synchronized movement of both motors is regulated by means of a synchronism circuit 52 provided with an external connection 53 for a control unit 54 independently calibrated for both motors and in the hands of maintenance personnel, with which part 8 or piece 15 will be periodically calibrated. Besides, due to the independent action on the motors, their levelling may also be adjusted.

The invention particularly considers the fitting of two end motors 51 in relation to the mobile part 8, or its support piece 15 in the case where it is made up of an interchangeable plate, which will facilitate levelling.

According to a variation of the invention shown in FIG. 12, the motors 51 are fitted with a reducer, not shown, and cams 56 that directly move part 8 or piece 15.

Another variation of the invention, shown in FIG. 13, considers the use of electromechanical linear actuators 57 with positional control whose rod 58 moves linearly and directly actuates on part 8 or piece 15.

Having sufficiently described the nature of the invention, as well as the way to embody it in practice, it must be emphasized that the previously indicated layouts, represented in the attached drawings, may be modified in detail as long as they do not alter the fundamental principle.

1-5. (canceled)

6. Means to operate the mobile part of an advertisement display stand with image renewal; the aforementioned display stand being the type comprising a casing with internal illumination and a window or opening to display changing images generated by means of an internally fitted fixed transparent part and another transparent parallel, mobile part facing it, one of them fitted with an opacity mask and the other with a number of fragmented images which are interspersed in line with the opacity pattern, so that by adjusting the position of the mobile part in relation to the fixed part, the visualization through the open spaces of the opacity mask of the fragments of one of the images or another in cooperation with the internal lighting may be selected; and the part that has the images being able to be made up of an interchangeable, flexible plate, facing the fixed part, supported by a rigid, transparent piece to which movement is applied; whereas the fixed and mobile parts may each be fitted into frames joined together by hinges, making an accessible structure with means to rapidly fit it into an urban street furniture display stand, provided with its own internal illumination; the aforementioned means being characterised by having a number of motors that act on different areas of the mobile part or piece that supports the interchangeable plate; these motors being synchronised by means of a circuit that enables their calibration and levelling.

7. Means according to claim 6, wherein the synchronism circuit of the motors being provided with an external connection for adjustment and calibration by means of an external, detachable control unit.

8. Means according to claim 6, wherein the motors having positional control and each joined by means of a reducer to cams that act on the mobile part or piece that supports the interchangeable plate.

9. Means according to claim 6, wherein the motors having electromechanical, linear actuators with positional control, whose rods directly act on the mobile part or piece that supports the interchangeable plate.

10. Means according to claim 6, wherein ideally having two motors or actuators corresponding to both lateral end areas of the mobile part or piece that supports the interchangeable plate.
